(19) United States
(12) Patent Application Publication
(10) Pub. No.: US 2024/0311624 A1
(43) Pub. Date: Sep. 19, 2024

(54) MULTIPLICATION-ACCUMULATION CIRCUIT USED IN A NODE OF ARTIFICIAL NEURAL NETWORK

(71) Applicant: MEDIATEK INC., Hsin-Chu (TW)

(72) Inventor: Chun-Hao Wei, Hsinchu City (TW)

(73) Assignee: MEDIATEK INC., Hsin-Chu (TW)

(21) Appl. No.: 18/444,747

(22) Filed: Feb. 18, 2024

Related U.S. Application Data
(60) Provisional application No. 63/490,304, filed on Mar. 15, 2023.

(51) Int. Cl. G06N 3/063

(52) U.S. Cl. CPC G06N 3/063

(57) ABSTRACT

The present invention provides a multiplication-accumulation circuit including a switched capacitor module, a buffer and a voltage-to-delay converter. The switched capacitor is controlled by an input signal to receive a ramp signal to generate a voltage signal. The buffer is configured to receive the voltage signal to generate a buffered signal. The voltage-to-delay converter is configured to convert the buffered signal to an output delay signal having delay time information.

### CROSS REFERENCE TO RELATED APPLICATIONS

This application claims the benefit of U.S. Provisional Application No. 63/490,304, filed on Mar. 15, 2023. The content of the application is incorporated herein by reference.

### BACKGROUND

An artificial neural network is made up of multiple processing units called nodes that are organized into layers, wherein these layers are connected to each other via weights. Each node receives an input signal, and processes the input signal with the weights to generate an output signal to a following node. The conventional neural network circuit may need numerous fast Fourier transform (FFT) operations, however, FFT operation is not power efficient, and the neural network circuit using FFT operations needs analog-to-digital converters (ADC) and many digital memories for the processing of the nodes. In addition, the processing of the node within conventional neural network circuit may suffer settling insensitive and interference issue, which will affect its accuracy.

### SUMMARY

It is therefore an objective of the present invention to provide an analog multiplication-accumulation circuit to implement a node of the neural network circuit, to solve the above-mentioned problems.

According to one embodiment of the present invention, a multiplication-accumulation circuit comprising a switched capacitor module, a buffer and a voltage-to-delay converter is disclosed. The switched capacitor is controlled by an input signal to receive a ramp signal to generate a voltage signal. The buffer is configured to receive the voltage signal to generate a buffered signal. The voltage-to-delay converter is configured to convert the buffered signal to an output delay signal having delay time information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an artificial neural network according to one embodiment of the present invention.

FIG. 2 is a diagram illustrating a multiplication-accumulation circuit according to one embodiment of the present invention

FIG. 3 is a diagram illustrating a ramp signal, an input signal and an output delay signal according to one embodiment of the present invention.

FIG. 4 is a diagram illustrating a multiplication-accumulation circuit according to one embodiment of the present invention

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

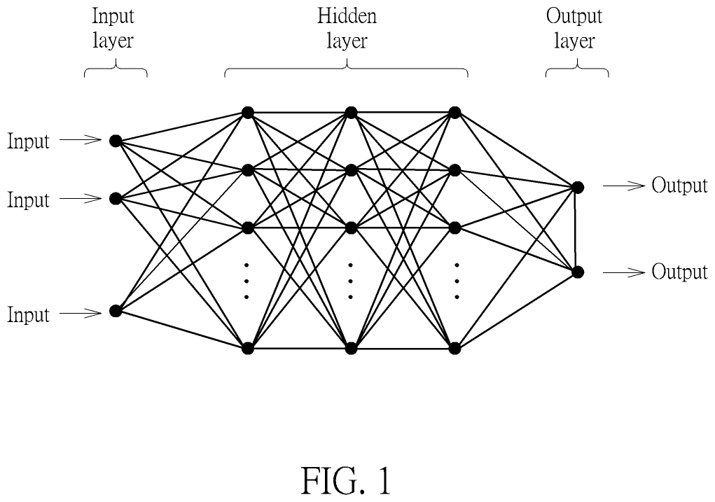

FIG. 1 is an artificial neural network according to one embodiment of the present invention. As shown in FIG. 1, the artificial neural network comprises three types of layers such as an input layer, one or more hidden layer and an output layer. The input layer is configured to receive input signals and pass them to the one or more hidden layer. The hidden layer (s) is/are configured to process the signals from the input layer to generate processed signals. Regarding each node of the hidden layer, the node can perform a weighted average or another weighted calculation upon the received signals to generate the processed signal. For example, if the node received three signals x1, x2 and x3, and the three signals x1, x2 and x3 have the weights W1, W2 and W3, respectively, the processed signal can be calculated by using the formula: y=(x1*W1+x2*W2+x3*W3). The output layer is configured to receive the processed signals from the hidden layer to generate final results. In this embodiment, the artificial neural network shown in FIG. 1 can be applied to any deep learning or recognition system such as voice recognition system.

As described in the background of the present invention, the conventional neural network circuit has ADCs and many digital memories for the processing of the nodes, and the processing of the node may suffer settling insensitive and interference issue. In order to solve these problems, the present invention designs an analog multiplication-accumulation circuit to implement a node of the artificial neural network, which has better accuracy and lower manufacturing costs, and can suppress the settling and interference issue.

It is noted that the architecture and the operations of the input layer, one or more hidden layer and the output layer are known by a person skilled in the art, and the present invention focuses on the analog circuit design of the nodes of the hidden layer, so the following content only describes the circuit design of the node.

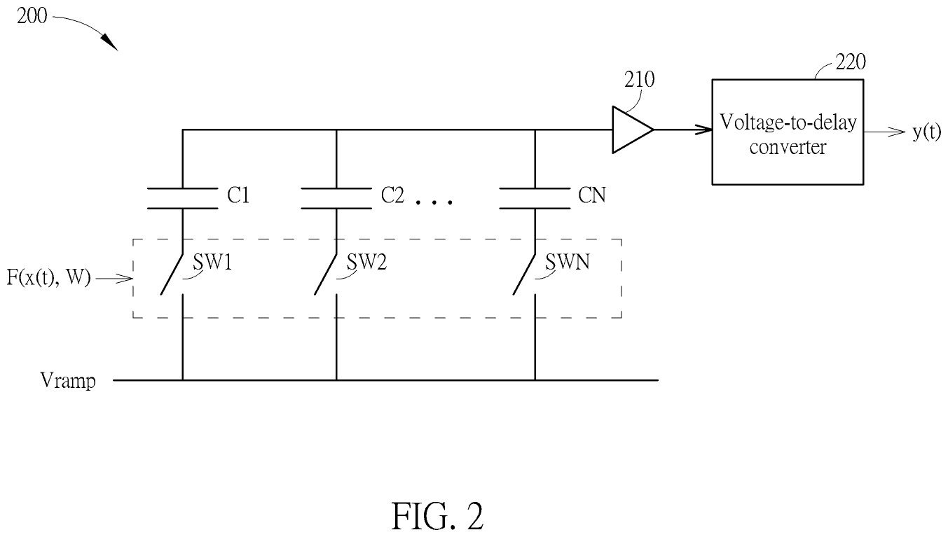

FIG. 2 is a diagram illustrating a multiplication-accumulation circuit 200 according to one embodiment of the present invention, wherein the multiplication-accumulation circuit 200 is configured to receive one or more input signals from the previous node to generate an output signal to a next node. As shown in FIG. 2, the multiplication-accumulation circuit 200 comprises a switched-capacitor module, a buffer 210 and a voltage-to-delay converter 220, wherein the switched-capacitor module comprises a plurality of switches SW1-SWN and a plurality of capacitors C1-CN. The switches SW1-SWN are coupled to lower plates of the capacitors C1-CN, respectively, and the switches SW1-SWN are used to selectively connect a ramp signal Vramp to the lower plates of the capacitors C1-CN, respectively. The upper plates of the capacitors C1-CN are coupled together. The buffer 210 is configured to receive a signal (voltage signal) at the upper plates of the capacitors C1-CN to generate a buffered signal, and the voltage-to-delay converter 220 converts the buffered signal to an output delay signal having delay time information to the next node.

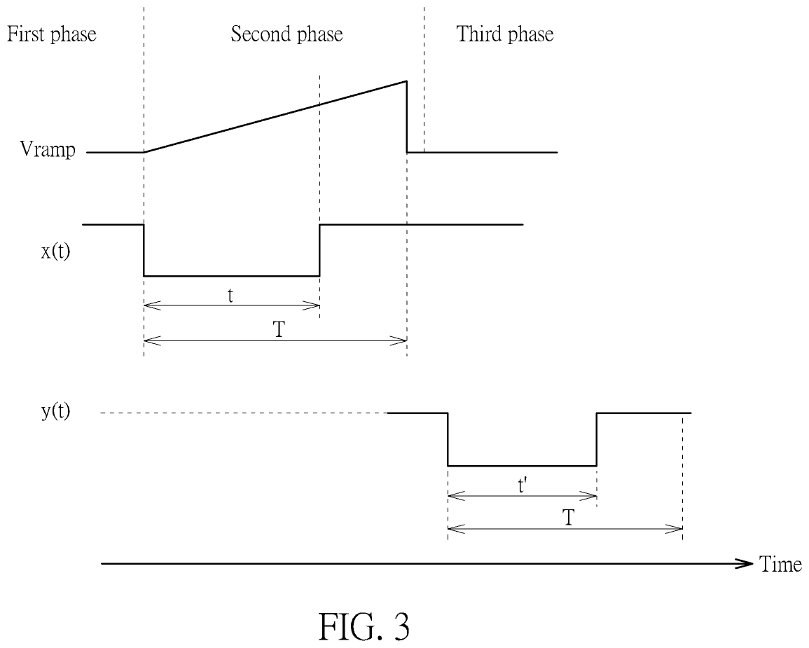

The switches SW1-SWN are controlled by one or more input signals x (t) and corresponding weights. In one embodiment, the weight corresponding to each input signal x (t) has one or more bits, and each bit of the weight is used with the input signal x (t) to control one switch. For example, the weight corresponding to the input signal x (t) has four bits W[1], W[2], W[3] and W[4], and the switches SW1-SW4 are controlled by the W[1], W[2], W[3] and W[4] with the input signal x(t), respectively, that is, if the input signal x (t) has an enabling state and W[1] is equal to “1”, the switch SW1 is enabled to connect the ramp signal Vramp to the capacitor C1; if the input signal x (t) has the enabling state and W[2] is equal to “1”, the switch SW2 is enabled to connect the ramp signal Vramp to the capacitor C2; if the input signal x (t) has the enabling state and W[3] is equal to “1”, the switch SW3 is enabled to connect the ramp signal Vramp to the capacitor C3; and if the input signal x (t) has the enabling state and W[4] is equal to “1”, the switch SW4 is enabled to connect the ramp signal Vramp to the capacitor C4. In addition, referring to FIG. 3, the input signal x (t) is a delay signal having delay time information “t”, wherein the input signal x (t) has a predetermined period “T”. In this embodiment, without a limitation of the present invention, the input signal x (t) with lower voltage level means that the input signal x (t) has the enabling state.

In the operation of the multiplication-accumulation circuit 200, referring to FIG. 2 and FIG. 3 together, initially the multiplication-accumulation circuit 200 operates in a first phase, and an input terminal and an output terminal of the buffer 210 are reset to have a reset voltage such as 0V. In a second phase immediately following the first phase, the ramp signal Vramp starts to gradually increase its voltage level, and a bit-wise multiplication is performed, that is the switches SW1-SWN are controlled by the input signal (s) with the corresponding weight to selectively connect the ramp signal Vramp. For example, if the input signal x (t) has the enabling state (e.g., low voltage level) and W[1] is equal to “1”, the switch SW1 is enabled to connect the ramp signal Vramp to the capacitor C1, and a voltage level at the lower plate of the capacitor C1 is gradually increased until the input signal x(t) does not the enabling state (e.g., high voltage level). Referring to FIG. 3, the input signal x (t) has the delay time information “t”, and when the input signal x (t) enters high voltage level from the low voltage level, the switch SW1 is disabled, and the lower plate of the capacitor C1 will maintain the previous voltage level (i.e., “Vx” shown in FIG. 3).

In a third phase immediately following the second phase, the ramp signal Vramp is back to its original voltage level (e.g. 0V), and a charge accumulation occurs at the upper plates of the capacitors C1-CN. For example, the charge accumulation at the at the upper plates of the capacitors C1-CN is similar to ΣC*W*x, wherein “x” is equal to “t/T”. Then, the buffer 210 receives the signal at the upper plates of the capacitors C1-CN to generate a buffered signal, and the voltage-to-delay converter 220 converts the buffered signal to an output delay signal y (t) having delay time information t′ to the next node, wherein the output delay signal y(t) has the predetermined period “T”. In one embodiment, the voltage-to-delay converter 220 comprises a rectified linear unit (ReLU) to convert the buffered signal to the output delay signal.

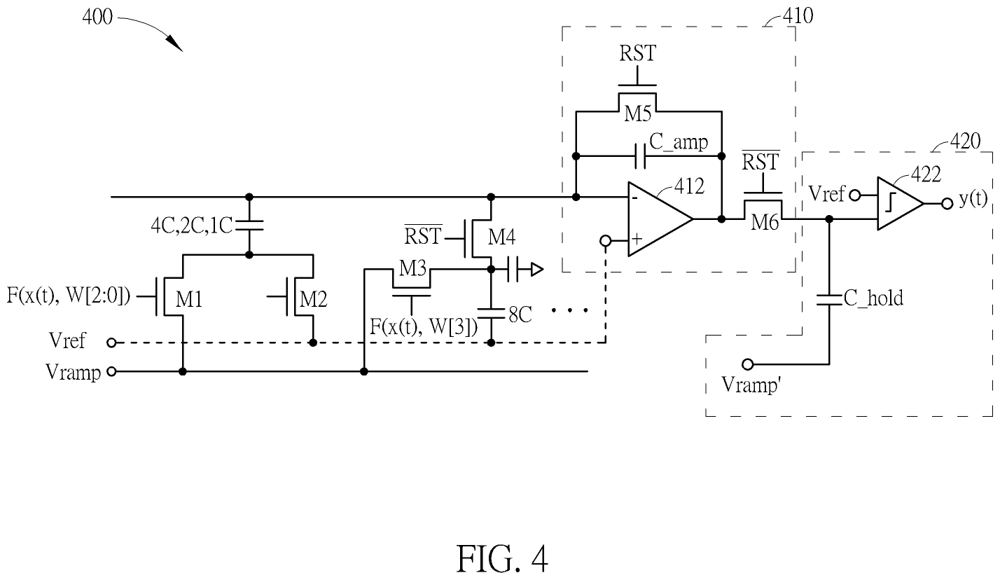

FIG. 4 is a diagram illustrating a multiplication-accumulation circuit 400 according to one embodiment of the present invention, wherein the multiplication-accumulation circuit 400 is configured to receive one or more input signals from the previous node to generate an output signal to a next node. As shown in FIG. 4, the multiplication-accumulation circuit 400 comprises a switched-capacitor module, buffer 410 and a voltage-to-delay converter 420, wherein the switched-capacitor module comprises plurality of switches and a plurality of capacitors whose capacitance are 80, 4C, 2C and 1C. In this embodiment, the switch corresponding to the capacitor whose capacitance are 4C, 2C or 1C comprises a transistor M1 and a transistor M2, wherein the transistor M1 is controlled by a function of an input signal x (t) and corresponding weight W[2:0], and the transistor M2 is controlled by the corresponding weight. For each switch, the transistor M1 is used to selectively connect a ramp signal Vramp to a lower plate of the capacitor, and the transistor M2 is used to selectively connect a reference voltage Vref (e.g. 0V) to the lower plate of the capacitor. In addition, the switch corresponding to the capacitor whose capacitance is 8C comprises a transistor M3 and a transistor M4, wherein the transistor M3 is controlled by a function of an input signal x(t) and corresponding weigh W[3], and the transistor M4 is controlled by an inverted signal of a reset signal RST. For each switch corresponding to the capacitor whose capacitance is 8C, the transistor M3 is used to selectively connect the ramp signal Vramp to an upper plate of the capacitor, and a lower plate of the capacitor is coupled to the reference voltage Vref.

The buffer 410 comprises an amplifier 412, a capacitor C_amp, and two switches (a transistor M5 and a transistor M6 serve as the two switches). A positive input terminal of the amplifier 412 is connected to the reference voltage Vref, the capacitor C_amp is coupled between a negative input terminal and an output terminal of the amplifier 412, and the transistor M5 is selectively connect the negative input terminal to the output terminal of the amplifier 412 according to the reset signal RST. In addition, the transistor M6 is controlled by the inverted signal of the reset signal RST, and the transistor M6 is configured to selectively connect the output terminal of the amplifier 412 to the voltage-to-delay converter 420.

The voltage-to-delay converter 420 comprises a capacitor C_hold and a comparator 422, wherein the comparator 422 receives a ramp signal Vramp′ via the capacitor C_hold, and the comparator 422 compares the ramp signal Vramp′ with the reference voltage Vref to generate an output delay signal having delay time information to the next node.

In the operation of the multiplication-accumulation circuit 400, referring to FIG. 4 and FIG. 3 together, initially the multiplication-accumulation circuit 400 operates in a first phase, and the reset signal RST is enabled (e.g. RST=1) so that the transistor M5 is configured to connect the negative input terminal to the output terminal of the amplifier 412, to make the voltage levels the negative input terminal and the output terminal of the amplifier 412 be equal to the reference voltage. Meanwhile, the reference voltage Vref is connected to the transistor M2 and the capacitor whose capacitance is 8C. In addition, the transistor M6 is disabled so that the output terminal of the amplifier 412 is disconnected from the voltage-to-delay converter 420.

In a second phase immediately following the first phase, the switched capacitor module is disconnected from the reference voltage Vref, the ramp signal Vramp starts to gradually increase its voltage level, and a bit-wise multiplication is performed, that is the switches are controlled by the input signal (s) with the corresponding weight to selectively connect the ramp signal Vramp. At this time, the reset signal RST is also enabled so that the transistor M5 is enabled while the transistors M4 and M6 are disabled. For example, if the input signal x (t) has the enabling state (e.g., low voltage level) and W[2:0] is equal to “1”, the transistor M1 is enabled to connect the ramp signal Vramp to the corresponding capacitor, and a voltage level at the lower plate of the corresponding capacitor is gradually increased until the input signal x(t) does not the enabling state (e.g., high voltage level). Referring to FIG. 3, the input signal x (t) has the delay time information “t”, and when the input signal x (t) enters high voltage level from the low voltage level, the transistor M1 is disabled, and the lower plate of the corresponding capacitor will maintain the previous voltage level (i.e., “Vx” shown in FIG. 3). In addition, the switch having the transistor M3, M4 and the capacitor whose capacitor is 8C is used to provide negative charges, that is if the input signal x (t) has the enabling state and W[3] is equal to “1”, the transistor M3 is enabled to connect the ramp signal Vramp to the upper plate of the corresponding capacitor and the upper plates of the other capacitors.

In a third phase immediately following the second phase, the ramp signal Vramp is back to its original voltage level (e.g. 0V), and a charge accumulation occurs at the upper plates of the capacitors. In the third phase, the reset signal RST is disabled (e.g., RST=0) so that the transistor M5 is disabled while the transistors M4 and M6 are enabled. At this time, the capacitor whose capacitance is 8C is coupled to the upper plates of the other capacitors whose capacitance are 4C, 2C and 1C via the transistor M4, causing the upper plates of the capacitors (i.e., the negative input terminal of the amplifier 412) is a charge conservation point. In addition, because the lower plates of the capacitors are reconnected to the reference voltage Vref, the charge x*W on the capacitor will be accumulated at the charge conservation point and reflected to the output terminal of the amplifier 412 through the buffer 410. For example, the charge accumulation at the at the upper plates of the capacitors C1-CN is similar to ΣC*W*x, wherein “x” is equal to “t/T”. Then, the amplifier 412 receives the signal at the upper plates of the capacitors to generate a buffered signal, and the voltage-to-delay converter 420 converts the buffered signal to an output delay signal having delay time information to the next node. In this embodiment, the buffered signal generated by the amplifier 412 is combined with the ramped signal Vramp′ to generate a combined signal, and the comparator 422 compares the combined signal with the reference voltage Vref to generate the output delay signal.

In one embodiment, because the buffered signal generated by the amplifier 412 may have gain loss due to a normalization of the charge conservation (i.e., the voltage generated by the charge accumulation is less than the ideal voltage), the ramp signal Vramp′ received by the voltage-to-delay converter 420 has smaller slope that the ramp signal Vramp received by the switched capacitor module. For example, the slope of the ramp signal Vramp′ can be one-half or one-quarter of the slope of the ramp signal Vramp. By using the ramp signal Vramp′ with smaller slope, the delay time of the output delay signal will be increased to compensate the gain loss mentioned above.

Briefly summarized, in the multiplication-accumulation circuit of the present invention, the input signal is a delay signal, and the multiplication-accumulation circuit uses switched capacitor module and a ramp signal to convert the input signal to an output delay signal to a next node of the artificial neural network. Therefore, the multiplication-accumulation circuit can have better accuracy and lower manufacturing costs, and can suppress the settling and interference issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multiplication-accumulation circuit, comprising:
a switched capacitor module, wherein the switched capacitor is controlled by an input signal to receive a ramp signal to generate a voltage signal;
a buffer, configured to receive the voltage signal to generate a buffered signal; and
a voltage-to-delay converter, configured to convert the buffered signal to an output delay signal having delay time information.

2. The multiplication-accumulation circuit of claim 1, wherein the switched capacitor module comprises a plurality of switches and a plurality of capacitors; and for at least a portion of the plurality of switches, each switch is configured to selective connect the ramp signal to a lower plate of the corresponding capacitor according to the input signal.

3. The multiplication-accumulation circuit of claim 2, wherein the input signal is a delay signal, and each switch is configured to selective connect the ramp signal to the lower plate of the corresponding capacitor according to the input signal and a corresponding weight.

4. The multiplication-accumulation circuit of claim 2, wherein the buffer comprises:
an amplifier, configured to receive the voltage signal and a reference voltage to generate the buffered signal;
a first capacitor, coupled between an input terminal and an output terminal of the amplifier; and
a first switch, coupled between the input terminal and the output terminal of the amplifier.

5. The multiplication-accumulation circuit of claim 4, wherein when the multiplication-accumulation circuit operates in a first phase, the first switch is enabled to make voltage levels input terminal and the output terminal of the amplifier be equal to the reference voltage; and when the multiplication-accumulation circuit operates in a second phase following the first phase, the first switched is disabled, and each switch is configured to selective connect the ramp signal to the lower plate of the corresponding capacitor according to the input signal; and when the multiplication-accumulation circuit operates in a third phase following the second phase, a charge accumulation occurs at upper plates of the capacitors to generate the voltage signal for the buffer to generate the buffered signal, and the voltage-to-delay converter converts the buffered signal to the output delay signal having delay time information.

6. The multiplication-accumulation circuit of claim 1, wherein the ramp signal received by the switched capacitor module is a first ramp signal; and the voltage-to-delay converter converts the buffered signal to the output delay signal having the delay time information according to a second ramp signal.

7. The multiplication-accumulation circuit of claim 6, wherein the second ramp signal is different from the first ramp signal.

8. The multiplication-accumulation circuit of claim 7, wherein a slope of the second ramp signal is smaller than a slope of the first ramp signal.

9. The multiplication-accumulation circuit of claim 6, wherein the voltage-to-delay converter comprises a comparator, the comparator compares a combined signal with a reference voltage to generate the output delay signal, and the combined signal is generated by the second ramp signal and the buffered signal.

10. The multiplication-accumulation circuit of claim 1, wherein the multiplication-accumulation circuit is used in a node of an artificial neural network.
